(19) United States
(12) Patent Application Publication
(10) Pub. No.: US 2004/0267748 A1
(43) Pub. Date: Dec. 30, 2004

(54) System for accessing web page using real name and method thereof

(76) Inventors: Jeen-Hyun Bae, Seoul (KR); Pan-Jung Lee, Seoul (KR)

Correspondence Address: FISH & RICHARDSON PC, 225 FRANKLIN ST, BOSTON, MA, 02110, US

(21) Appl. No.: 10/489,810

(22) PCT Filed: May 21, 2002
(86) PCT No.: PCT/KR02/00958

(30) Foreign Application Priority Data
Sep. 17, 2001 (KR) 2001-0057361

(51) Int. Cl. G06F 17/30

(52) U.S. Cl. 707/9

(57) ABSTRACT

A web page access system and method using a real name. It is determined whether a keyword input from a client accessed through a name server management system is a real name, and when it is a real name, it is determined whether it is a specified keyword, and when it is found to be a specified keyword, the keyword is provided to a search server so that the search server provides search information matched with the keyword to the client. When the keyword is not a specified keyword, a network address matched with the keyword is provided to the client to that the client accesses a web page corresponding to the network address. Therefore, the client directly accesses the corresponding web page according to keyword features or receives search information matched with the keyword by inputting the keyword once, and accordingly, the client accurately accesses the desired web page.

### BACKGROUND OF THE INVENTION

(a) Field of the Invention

The present invention relates to a web page access system and method using a real name. More specifically, the present invention relates to a web page access system and method using a real name including English, Korean, and other foreign languages for accessing corresponding web pages on the network.

(b) Description of the Related Art

The Internet is not a mere combined network of several computers, but it is a huge connection network of various and different computers' networks, and the respective computers connected to the Internet have addresses, that is, IP (Internet protocol) addresses for distinguishing the computers.

However, since the addresses have four groups including numbers that are not greater than 255 (e.g., 134.78.238.99), it is very difficult for users to memorize the numbers, and it is very annoying for the users to write the IP addresses each time they attempt to access a predetermined computer connected through the Internet.

Therefore, a method for matching the IP addresses with easily memorable combinations of strings one by one and automatically accessing a computer that has an IP address when the user inputs a corresponding string is used, instead of directly using physical addresses to access respective computers. The combination of the characters used instead of the IP addresses is referred to as a domain name.

When the domain name is registered using a service provider that provides a recently and frequently used web hosting service that has no actual host computer matched with the domain name but allows those who desire to have their domain names registered to be registered through the service provider's host computer, at least one domain name may be matched with the IP address.

As described above, the domain name refers to an Internet address of a computer connected to the Internet, and generally includes identifiers that represent the corresponding computer's features or geographical location. For example, “ABC.co.kr” of an email address “james@ABC.co.kr” denotes the substantial domain name, and “ABC.co.kr” of “http://www.ABC.co.kr” that is a URL (uniform resource location) representing an IP address system shows the substantial domain name. For another example, in the URL of “http://www.internic.net/index.html” showing an address of various kinds of information provided from the Internet-connected computer, “internic.net” indicates a domain name, and “index.html” represents a file name including a directory storing corresponding information.

Hence, in order to use not an IP address of each computer but a domain name, an additional device for matching each computer's IP address with a domain name is required, and therefore, each computer connected to the Internet according to this requirement is related to a computer system for performing the above-noted function, that is, a domain name server (DNS).

When a client generally requests to check an IP address of a corresponding computer's domain name such as “def.co.kr” from an established DNS so as to access the Internet's predetermined computer, the DNS inquires for an IP address matched with the input domain name of a server of a registration agency that manages IP addresses, and provides the IP address provided by the server of the registration agency to the client, and accordingly, the client accesses the computer that has the corresponding IP address.

As described above, the user must know the corresponding domain name so as to access a predetermined computer on the Internet, but since the domain name generally includes a combination of English letters following a predetermined rule, non-English speaking peoples such as Koreans, Japanese, and Chinese have relative difficulty in memorizing the domain names.

Recently, systems for using a domain name on the mother tongue basis to access the client to the corresponding web page have been developed so that services for accessing the client to the corresponding web page when the user inputs a real name that has a domain name format different from the conventional one on the web browser and that has an actual mother tongue are provided.

However, since the conventional web page access systems may problematically connect the clients to wrong web pages, the user must repeatedly input keywords so as to access a desired web page, and they must also iterate the web page access process each time errors have occurred.

### SUMMARY OF THE INVENTION

It is an object of the present invention to provide a web page access system and a method thereof for using a real name to accurately connect a client to desired web pages.

In this instance, the web page represents a server for providing network-based services including the WWW (world wide web), electronic mail, the FTP (file transfer protocol), and the telnet.

In one aspect of the present invention, a web page access system connected to a plurality of clients through a network, for accessing the clients to predetermined web pages on the network comprises: a keyword database for storing specified keywords; a real name database for storing network addresses and real names matched with the network addresses; a processing server for providing a keyword to a search server so that the search server provides search information matched with the keyword to the client, when the keyword input from the client is a real name and a specified keyword; and a real name server for searching the real name database to find a matched network address on the basis of the keyword when the keyword is a real name and not a specified keyword, and providing the network address to the client so that the client may access a web page corresponding to the network.

In another aspect of the present invention, a web page access system connected to a plurality of clients through a network, for accessing the clients connected through a name server management system to a predetermined web page comprises: a keyword database for storing specified keywords; a real name database for storing network addresses and real names matched with the network addresses; a name server management system database for storing search server information for each name server management system; a processing server for selecting a search server matched with a name server management system gone through by the client from the name server management system database when the keyword input from the client is a real name and a specified keyword, and providing the keyword to the selected search server so that the search server provides search information corresponding to the keyword to the client; and a real name server for searching the real name database to find a matched network address on the basis of the keyword when the keyword is a real name and not a specified keyword, and providing the network address to the client so that the client may access a web page corresponding to the network address.

The name server management system comprises a name server for determining whether the keyword input from the client is a real name, and it provides the keyword to the processing server when the input keyword is a real name; and the processing server determines the name server management system gone through by the client according to the client's IP address, and provides the specified keyword to the search server matched with the determined name server management system.

The search server provides the client with a search result page displaying the keyword together with search information corresponding to the keyword, and requests a network address from the real name server when the client clicks the keyword; and the real name server finds a network address matched with the keyword from the real name database to provide the network address to the search server, so that the client accesses the web page matched with the network address.

The system further comprises a web server for providing a keyword input window to the client accessing through the network, and the web server provides the keyword to the real name server to determine whether the keyword is a real name when the keyword is input from the client through the keyword input window.

The client provides the keyword to the processing server in various ways, and in detail, the client comprises an application program for checking a keyword input operation and providing the input keyword to the processing server, and the client provides the keyword to the processing server through a web browser.

In still another aspect of the present invention, a web page access method connected to a plurality of clients and search servers through a network, for accessing the client accessing through a name server management system to a predetermined web page on the network comprises: (a) determining whether a keyword input from the client is a real name; (b) determining whether the keyword is a specified keyword when the keyword is a real name; (c) providing the keyword to one of the search servers and enabling the search server to provide search information matched with the keyword to the client, when the keyword is a specified keyword; and (d) providing an IP address matched with the keyword to the client and enabling the client to access a web page matched with the IP address, when the keyword is not a specified keyword.

The method further comprises: (e) determining the name server management system gone through by the client; and in (c), the keyword is provided to the search server matched with the name server management system gone through by the client; and in (e), the name server management system gone through by the client is determined according to the client's IP address.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows a block diagram of a real-name using web page access system according to a first preferred embodiment of the present invention;

FIGS. 2(a) and 2(b) show a flowchart of an operation of the real-name using web page access system according to the first preferred embodiment of the present invention; and

FIG. 3 shows a block diagram of a real-name using web page access system according to a second preferred embodiment of the present invention.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

The web page access system using a real name according to the preferred embodiments of the present invention additionally sets real names including foreign languages, numbers, and symbols as well as Korean and English corresponding to all Internet addresses registered to the Internet, thereby enabling real-name web page access. In this instance, the real names include all formats except the conventional domain name format.

For easy explanation of the following, the URLs including the existing domain names and file names are referred to as “English domain names,” a server for providing a service for checking Internet addresses of the existing domain names is referred to as a “domain name server,” and strings input from a client so as to access a predetermined web page are referred to as “keywords.” Therefore, the “keywords” representing domain names include “English domain names” and “real names.” In the preferred embodiment of the present invention, the “real names” represent actual names including firm names, titles, and services. IP addresses and URLs of predetermined web pages on the Internet are referred to as Internet addresses.

In order to accurately connect the client to a desired web page, the web page access system according to the preferred embodiment of the present invention directly connects the client to a corresponding web page according to an Internet address matched with a corresponding keyword when the keyword input from the client is a real name and not a specified keyword. The web page access system provides the keyword to a search server so that various sorts of search information matched with the keyword may be provided to the client, and the client may accordingly select and access a desired web page when the input keyword is a specified keyword. In this instance, the specified keyword represents a keyword registered by the search server to receive a search service and a direct link service, and the direct link service connects the client to a corresponding web page when the client selects a keyword on a search result page that provides search information. For example, the specified keyword includes a general noun such as “school” and a living information keyword related to living information.

Also, the web page access system cooperates with a name server management system for providing a network access service to the client, and selects a search server for providing a keyword according to the name server management system gone through by the client. In this instance, the name server management system includes an existing ISP (Internet service provider), a management system of each service provider that provides a network access service through an exclusive line, and a name server for providing network addresses.

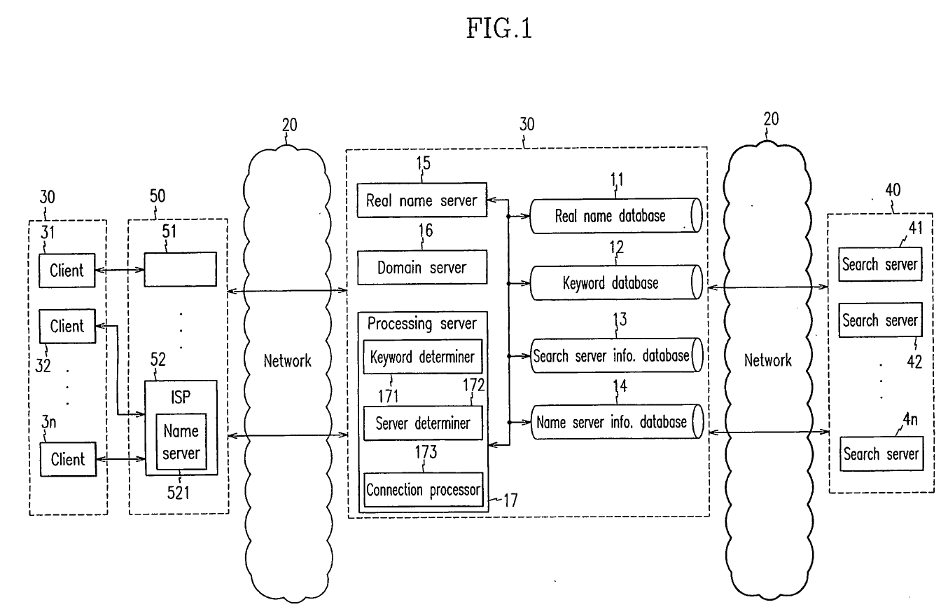

FIG. 1 shows a configuration of a web page access system using a real name according to a preferred embodiment of the present invention.

As shown, the web page access system using a real name comprises an access agency system 10 connected to a plurality of clients 30 (31 through 3n) through a network 20, and a name server management system 50 (51 through 5n), and the web page access system is connected to a search server 40 (41 through 4n). In this instance, the connection through the network is not restricted to hardwired connections.

The client 30 includes communication devices for accessing the access agency system 10 through the network 20, such as a computer, a mobile terminal, and an Internet TV. In particular, the client 30 is connected to the access agency system 10 on the network 20 through the name server management system 50 (51 through Sn) (e.g., an Internet service provider), and it provides keywords for accessing predetermined web pages to the name server management system 50.

The name server management system 50 connects the client 30 to the network 20, and in the preferred embodiment of the present invention, it may include a name server 521 for determining whether a keyword provided from the client 30 is a real name as shown in the name server management system 52, or it may not include a name server as shown in the name server management system 51. In this instance, the name server may process the real names and the conventional English domain names.

The access agency system 10 represent a site that provides an access agency service for using English domain names or real names and connecting clients that desire to access predetermined web pages on the Internet 20 to the corresponding web pages, and in particular, it directly connects the client 30 to the corresponding web page according to the keyword provided from the client 30 accessed through the name server management system 50 or provides the input keyword to a predetermined search server so that the client 30 receives various kinds of search information on the keyword and accesses the desired web page.

To achieve this, the access agency system 10 comprises a real name database 11, a keyword database 12, a search server information database 13, a name server management system information database 14 (referred to as a name server information database hereinafter), a real name server 15, a domain name server 16, and a processing server 17.

The real name database 11 stores at least one real name matched with all IP addresses on the network 20, and further stores URL information matched with each real name. For example, the real name database 11 stores a real name of “Netpia” corresponding to the IP address of “210.103.175.66” and stores URL information of “netpia.net” corresponding to “Netpia.”

The keyword database 12 stores a plurality of specified keywords registered through the search server 40 to receive a search and direct link service.

The search server information database 13 stores category-based information on a plurality of search servers that cooperate with the access agency system 10 and provide various sorts of search information on the keyword input by the client 30. For example, it stores searcher server information (e.g., URL information) for providing striking hit ratios for respective categories such as history, science, society, and economy, and information on the keywords matched with corresponding fields.

The name server information database 14 stores IP addresses registered for the respective name server management systems for providing the Internet access service, and related search server information (e.g., URL information) for the respective name server management systems. For example, it stores all the IP addresses registered to KT (Korea Telecom) corresponding to KT, that is, a name server management system service provider, and also stores “hanmir.co.kr” which is a URL of “Hanmir”, that is, a KT-related search site.

The respective servers 15 through 17 are operated on the basis of information stored in the databases 11 through 14, the domain name server 16 processes the conventional English domain names to provide matched Internet addresses, the real name server 15 determines whether the keyword provided from the client 30 is a real name, and when the keyword is found to be a real name, the real name server 15 searches for a corresponding IP address from the real name database 11 and provides the same to the client 30. When a keyword that is a real name is provided from the search server 40, the real name server 15 also searches the real name database 11 to provide a corresponding IP address to the search server.

The processing server 17 comprises: a keyword determiner 171 for searching the keyword database 12 on the basis of the keyword provided from the client 30 to determine whether the provided keyword is a specified keyword; a name server management system determiner 172 (referred to as a server determiner hereinafter) for searching, when the provided keyword is a specified keyword, the name server information database 14 on the basis of the IP address of the client 30 to determine the name server management system the client 30 is accessed through, and providing the keyword to the search server matched with the name server management system that the client 30 has gone through; and a connection processor 173 for connecting the client 30 to the corresponding web page according to URL information matched with the keyword or providing URL information to the search server 40, when at least one real name is matched with the IP address corresponding to the keyword, that is, when the corresponding IP address is not a real IP.

In the preferred embodiment of the present invention, the keyword determiner, the server determiner, and the connection processor of each processing server may be implemented as individual servers.

An operation of the web page access system using a real name according to the preferred embodiment of the present invention will now be described in detail.

In the preferred embodiment of the present invention, the client 30 is exemplified to execute an Internet access environment setting program before driving an Internet browser, and sets the name server 521 of the name server management system 52 as a server for providing an IP address checking service. In this instance, it is desirable to previously back up a generally used domain name server's IP address value and to return it when the Internet access environment setting program is terminated so that no modification may be generated due to the default usage of the client 30.

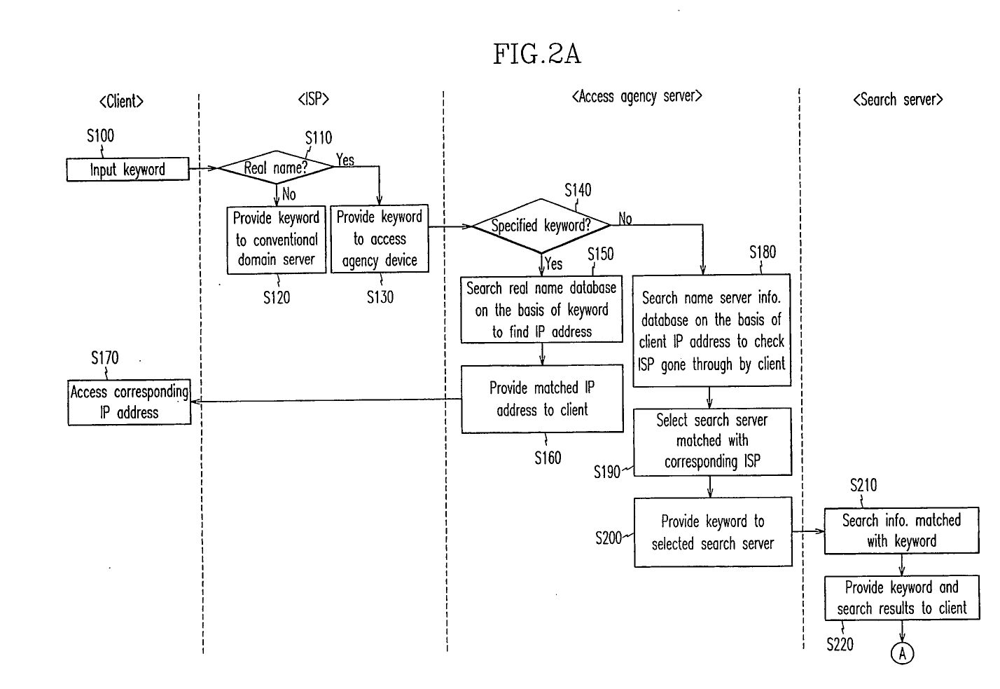

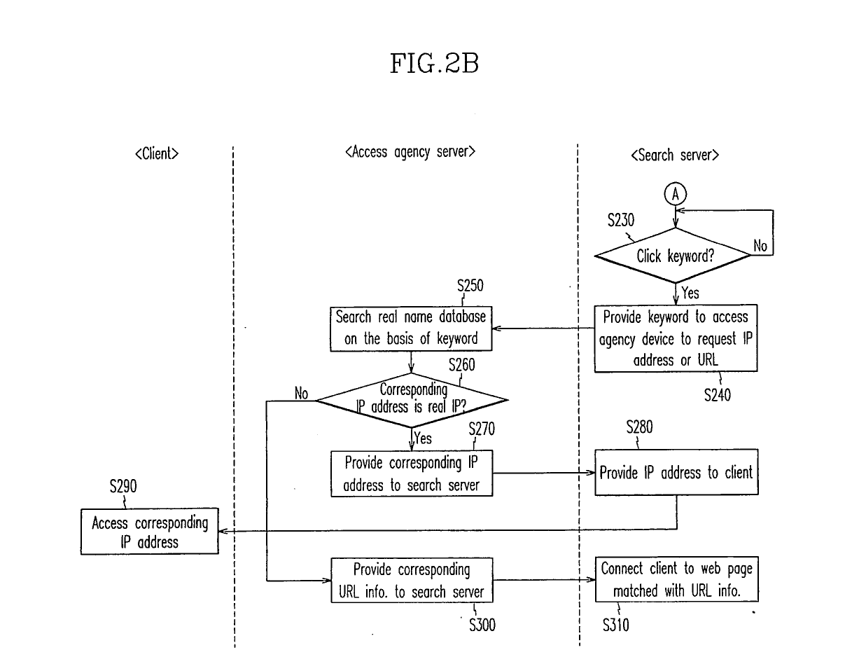

FIGS. 2(a) and 2(b) show a flowchart of an operation of the web page access system using a real name according to the preferred embodiment of the present invention.

As shown by FIG. 2(a), when a user drives an Internet access web browser (a general web browser such as the Netscape, and a web page access-only program provided by an access agency system) or an email program at the client 30, and inputs a keyword to an access word input window on the corresponding browser, the input keyword is provided to the name server 521 of the name server management system 52 in step S100.

The name server 521 of the name server management system 52 determines whether the keyword provided from the client 30 is a real name in step S110, for example when the input keyword includes an identifier “.” In the case of “netpia.net,” the name server 521 determines the input keyword to be a conventional domain name, and processes the conventional domain name in step S120.

When the input keyword includes no identifier “.”, the name server 521 determines the keyword to be a real name, and provides the keyword to the access agency system 10 to request a matched IP address in step S130. In this instance, the name server 521 of the name server management system 52 provides the keyword together with the IP address of the client 30 to the access agency system 10. Here, it is determined whether the corresponding keyword is a real name or not according to an inclusion state of the identifier “.” in the keyword, and the method for determining the real name is not restricted to this.

The processing sever 17 of the access agency system 10 provides a corresponding IP address to the name server management system 52 or provides the keyword to the search server 40 according to whether the keyword provided from the name server management system 52 is a specified keyword.

The keyword determiner 171 of the processing server 17 determines in step S140 whether the keyword provided from the name server management system 5 is stored in the keyword database 12, and when the corresponding keyword is not stored in the keyword database 12 the keyword is determined not to be a specified keyword, so the keyword determiner 171 searches the real name database 11 to find an IP address matched with the keyword and provides it to the name server management system 52. Accordingly, the name server 521 of the name server management system 52 provides the client 30 with the IP address provided from the access agency system 10, and the client 30 is accessed to the web page matched with the IP address in steps S150 through S170.

When the keyword is stored in the keyword database 12 in the previous step S140, the keyword determiner 171 of the processing server 17 determines the keyword to be a specified keyword, and selects a search server to which the keyword will be provided. That is, the server determiner 172 searches the name server information database 14 on the basis of the IP address of the client 30 to check through which name server management system the client 30 has accessed, and to set the search server to provide the keyword according to check results.

A name server management system matched with the IP address of the client 30 is checked from the name server information database 14, a search server matched with the corresponding name server management system is selected, and the keyword input by the client 30 is provided to the selected search server 40 in steps S180 through S200.

When the keyword is provided from the access agency system 10, the search server 40 collects information including a corresponding keyword from a plurality of servers connected to the network 20, generates a search result page on the basis of the collection results and the keyword, and provides the same to the client 30 in steps S210 and S220.

For example, when the keyword provided from the name server 521 of the name server management system 52 is a proper noun such as “Patent & Trademark Office” and not a specified keyword, the IP address corresponding to “Patent & Trademark Office” is provided to the name server 521 of the name server management system 52 so that the client 30 may be directly accessed to the web page matched with “Patent & Trademark Office.” However, when the keyword input by the client 30 is an “auto” that is a general noun and the client 30 is accessed through the “KT” name server management system, the “auto” input by the client 30 is provided to the search server that manages the search site “Hanmir” related to “KT,” and accordingly, the search server collects various sorts of information matched with the “auto” and provides the collected information together with a direct link tag matched with the “auto” to the search result page. In this instance, the search server displays advertisements provided from a plurality of advertisement servers (not illustrated) on the search result page to thereby perform advertisement marketing to a plurality of clients that are accessed through the name server management system.

Auto Direct link

1. Dealway-Korea first Internet auto sales company
2. Libero-Internet auto sales
3. Icomescom(Ltd.)-Auto Internet service company

Therefore, the client 30 may read various sorts of information matched with the keyword from the search result page provided by the search server 40, and, if necessary, the client may click a keyword tag to access a corresponding web page.

As shown in FIG. 2(b), when the client 30 clicks the keyword on the search result page, the search server 40 requests an Internet address (e.g., an IP address and URL information) matched with the keyword from the access agency system 10, the real name server 15 of the access agency system 10 searches the real name database 11, and provides the corresponding IP address to the client 30 when the IP address matched with the keyword is a real IP, and the search server 40 provides the IP address to the client 30 again so that the client 30 may access the web page matched with the keyword in steps S230 through S290.

When the IP address matched with the keyword is not a real IP, that is, when at least one different real name is matched with the IP address matched with the keyword, the connection processor 173 of the processing server 17 provides URL information matched with the keyword to the search server 40, and the search server 40 accordingly connects the client 30 to the web page corresponding to the URL information in steps S300 and S310.

According to the preferred embodiment of the present invention, since the client may use a keyword that is a real name to directly access a corresponding web page, and he may receive various categories of information corresponding to the keyword without additionally accessing a search server, the client may accurately access the desired web page through a minimum of steps.

In the above preferred embodiment, the client sets the name server of the name server management system as a name server, and differing from this, the client may set the real name server of the access agency system as the name server.

In this case, the keyword input by the client is directly provided to the access agency system 10, the real name server 15 of the access agency system 10 determines whether the keyword is a real name, and the processing server 17 connects the client 30 to the corresponding web page or provides a search result page corresponding to the keyword to the client 30 through the search server 40 depending on whether the provided keyword is a specified keyword in the like manner of the above description when the corresponding keyword is a real name.

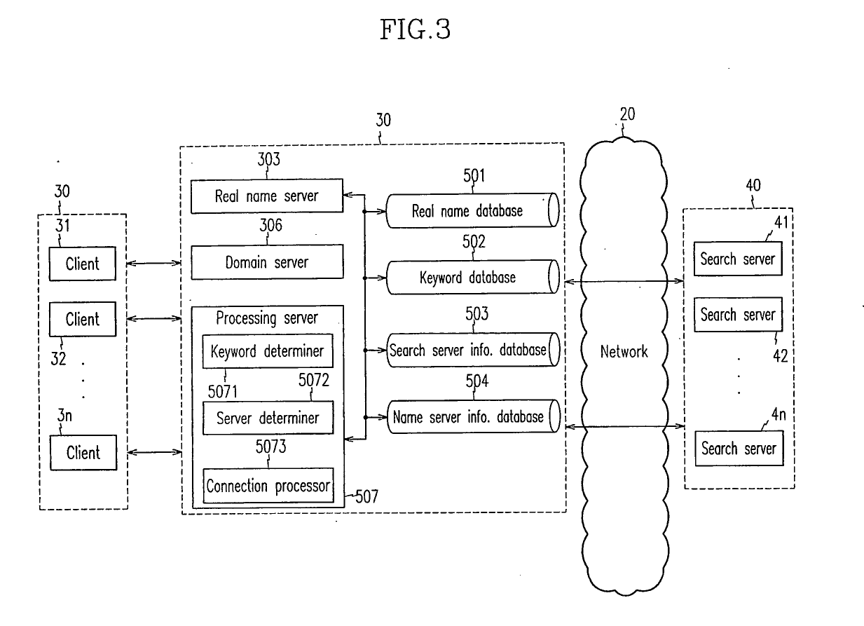

FIG. 3 shows a configuration of the web page access system using a real name according to a second preferred embodiment of the present invention.

As shown in the web page access system using a real name according to the second preferred embodiment of the present invention, the name management system 50 for performing an access agency function comprises a real name database 501, a keyword database 502, a search server information database 503, a name server information database 504, a real name server 505 for processing real names, a domain server 506 for processing conventional domain names, and a processing server 507. When a keyword is input from the client 30, the name management system determines whether the keyword is a specified keyword, and performs a web page access operation as described above according to determination results.

In this case, as described above, when the input keyword is a real name, the name server management system does not provide the keyword to the access agency system, but processes the keyword by itself to access the client to the corresponding web page or provide the keyword to the search server, thereby providing search information to the client.

In detail, the client 30 sets the real name server 505 of the name management system 50 as a name server, the keyword input from the client 30 is provided to the real name server 505 of the name management system 50, and when the keyword is not a real name, the domain name server 506 processes it, and when it is a real name, the input keyword is provided to the processing server 507. Since a subsequent operation of the respective keyword determiner 5071, the server determiner 5072, and the connection processor 5073 of the processing server 507 is matched with that of the above-noted embodiment, no detailed description will be provided.

Since the client 30 may receive a network access service through a different name server management system and specify the above-configured real name server 505 of the name server management system 50 as a name server, the server determiner 5072 of the processing server 507 may determine the name server management system gone through by the client 30 and select a search server 40 according to determination results as described above.

In the above-described preferred embodiments, an appropriate search server is selected according to the name server management system gone through by the client, and further, the search server may be selected according to the keyword input by the client. That is, a search server that provides the optimized hit ratio is selected according to the field to which the corresponding keyword belongs. For example, when the input keyword is a computer-related term, a search server for mainly searching for computer information is selected and the keyword is provided, and when the input keyword is an economy-related term, a search server for mainly searching for economy information is selected and the keyword is provided. Therefore, the user may accurately receive desired information through an optimized search server without specifying an additional search server.

In the web page access system using a real name according to the preferred embodiments of the present invention, a search and web page access service is provided to the keywords input through the web browser at the client, and without being restricted to this, the identical search and web page access service is provided in the case of providing the keywords through various methods.

In detail, when the client accesses the homepage of the access agency system and inputs a keyword on the homepage, when the client accesses the site that cooperates a keyword processing task with the access agency system and inputs a keyword into an input window of the cooperated site, when the client accesses the name server management system site and inputs a keyword, and when an application program installed in the client checks a keyword input operation and provides the input keyword, the search and web page access service is executed in the like manner of the above description. Also, when the client is a mobile terminal, the above-noted search and web page access service is provided, and in this case, the name server management system includes a system of a mobile communication service provider (e.g., 011 and 018 service providers) for providing a mobile communication service, and this system may include a name server provided by the access agency system to determine whether a keyword is a real name.

The client may specify not the name server of the name server management system for providing a network access function, but that of a different name serve management system as a name server, and in this case, the identical search and web page access service is provided. For example, when a client who performs a network access through KT sets Dacom's name server as a name server for receiving Internet addresses, the identical search and web page access service is executed.

Further, the access agency system records the access frequency of the clients who access the search server through the access agency system for each search server so that the access agency system may subsequently charge agency commissions for the respective search servers according to the access frequencies.

According to the preferred embodiments of the present invention, the client may not use the client's name server management system's name server but rather they use a different predetermined name server to receive a web page access service, and in this instance, the name, server may transmit a specified value (a keyword) to a predetermined site or a search site. Hence, the frequencies of page views or banner clicks increase by as many times as the name server transmits a specified value to the search site, and the search site pays the corresponding cost to the name server thereby sharing mutual profits.

In this case, the name server processes usage statistics of specified values into a database and provides a predetermined benefit to the client by a usage ratio, and accordingly, the user may earn a predetermined income only when using a name server that is essential to Internet usage, and also may generate new traffics for connecting the domain name to a predetermined search site or a predetermined page through a name server that converts domain names into IP addresses.

In addition, in the preferred embodiments of the present invention, the search server provides a plurality of keywords related to the keyword input from the client and enables receipt of a direct link service altogether on a search result page so that the user may select a keyword in various ways to access a corresponding web page.

The web page access system using a real name may be applicable to Internet email, the FTP (file transfer protocol), and the telnet, as well as the WWW (world wide web). Also, the web page access system is not restricted to the Internet, but it may be applied to various networks.

As described above, according to the web page access system, the client is directly connected to the corresponding web page according to keyword features or receives various sorts of search information matched with the keyword by inputting the keyword once.

Therefore, it is not required for the user to access an additional search server when attempting to receive search information, and the user may receive accurate information through a search server that provides a maximum hit ratio according to the keyword features.

Since the client may select a desired web page according to search information, the client accesses the web page through a minimum of steps.

Also, since search servers may obtain users of the name server management system's name server as search users, page views and ad banner views of the search server increase thereby creating more profits.

Further, since the web page access service using a real name is executed through a plurality of job-cooperated sites, the users may easily and quickly receive the access service through a plurality of sites without being restricted to a predetermined site.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A web page access system connected to a plurality of clients through a network, for accessing the clients to predetermined web pages on the network, comprising:
a keyword database for storing specified keywords;
a real name database for storing network addresses and real names matched with the network addresses;
a processing server for providing a keyword to a search server so that the search server provides search information matched with the keyword to the client, when the keyword input from the client is a real name and a specified keyword; and
a real name server for searching the real name database to find a matched network address on the basis of the keyword when the keyword is a real name and not a specified keyword, and providing the network address to the client so that the client may access a web page corresponding to the network.

2. A web page access system connected to a plurality of clients through a network, for accessing the clients connected through a name server management system to a predetermined web page, comprising:
a keyword database for storing specified keywords;
a real name database for storing network addresses and real names matched with the network addresses;
a name server management system database for storing search server information for each name server management system;
a processing server for selecting a search server matched with a name server management system gone through by the client from the name server management system database when the keyword input from the client is a real name and a specified keyword, and providing the keyword to the selected search server so that the search server provides search information corresponding to the keyword to the client; and
a real name server for searching the real name database to find a matched network address on the basis of the keyword when the keyword is a real name and not a specified keyword, and providing the network address to the client so that the client may access a web page corresponding to the network address.

3. The system of claim 2, wherein the name server management system comprises a name server for determining whether the keyword input from the client is a real name, and the name server provides the keyword to the processing server when the input keyword is a real name.

4. The system of claim 4, wherein the processing server determines the name server management system gone through by the client according to the client 's IP address, and provides the specified keyword to the search server matched with the determined name server management system.

5. The system of claim 2, wherein the search server provides the client with a search result page displaying the keyword together with search information corresponding to the keyword, and requests a network address from the real name server when the client clicks the keyword, and the real name server finds a network address matched with the keyword from the real name database to provide the network address to the search server so that the client accesses the web page matched with the network address.

6. The system of claim 1, wherein the processing server provides a keyword input window to the client accessing through the network, and provides the keyword to the real name server to determine whether the keyword is a real name when the keyword is input from the client through the keyword input window.

7. The system of claim 1 [or 2], wherein the client comprises an application program for checking a keyword input operation and provides the input keyword to the processing server.

8. The system of claim 1, wherein the client provides the keyword to the processing server through a web browser.

9. A web page access method connected to a plurality of clients and search servers through a network, for accessing the client accessing through a name server management system to a predetermined web page on the network, comprising:
determining whether a keyword input from the client is a real name;
determining whether the keyword is a specified keyword when the keyword is a real name;
providing the keyword to one of the search servers and enabling the search server to provide search information matched with the keyword to the client, when the keyword is a specified keyword; and
providing an IP address matched with the keyword to the client and enabling the client to access a web page matched with the IP address, when the keyword is not a specified keyword.

10. The method of claim 9, wherein the method further comprises: determining the name server management system gone through by the client, and the keyword is provided to the search server matched with the name server management system gone through by the client.

11. The method of claim 9, wherein the name server management system gone through by the client is determined according to the client's IP address.

12. The system of claim 2, wherein the processing server provides a keyword input window to the client accessing through the network, and provides the keyword to the real name server to determine whether the keyword is a real name when the keyword is input from the client through the keyword input window.

13. The system of claim 2, wherein the client comprises an application program for checking a keyword input operation and provides the input keyword to the processing server.

14. The system of claim 2, wherein the client provides the keyword to the processing server through a web browser.
